(19) United States
(12) Patent Application Publication
(10) Pub. No.: US 2015/0128085 A1
(43) Pub. Date: May 7, 2015

(54) Method, Device and Computer Storage Medium for Controlling Desktop

(71) Applicant: Tencent Technology (Shenzhen) Company Limited, Shenzhen (CN)

(72) Inventors: Yong PENG, Shenzhen (CN); Yanbing ZHANG, Shenzhen (CN)

(21) Appl. No.: 14/598,330

(22) Filed: Jan. 16, 2015

Related U.S. Application Data
(63) Continuation of application No. PCT/CN2013/079553, filed on Jul. 17, 2013.

(30) Foreign Application Priority Data
Jul. 19, 2012 (CN) 201210255743.4

(51) Int. Cl. G06F 3/0483

(52) U.S. Cl. CPC G06F 3/0483
USPC 715/777; 715/781

(57) ABSTRACT

Provided are method, device and computer storage medium for controlling desktop. The method includes: creating a first interface as a sub-window of a desktop container according to a creating instruction; and embedding the first interface created as the sub-window into the desktop container. The device includes: a sub-window creating module, configured to create a first interface as the sub-window of a desktop container according to a creating instruction; and an interface processing module, configured to embed the first interface created as the sub-window into the desktop container and display full-screen. The present disclosure is adopted to simplify operations among multiple interfaces in the desktop.

### CROSS-REFERENCE TO RELATED APPLICATION

This application is a continuation of PCT patent application No. PCT/CN2013/079553, entitled “Method, Device and Computer Storage Medium for Controlling Desktop” filed on Jul. 17, 2013, which claims priority to Chinese patent application No. 201210255743.4, entitled “Method and Device for Controlling desktop” filed on Jul. 19, 2012, both of which are incorporated by reference in their entirety.

### TECHNICAL FIELD

The present disclosure relates to open platforms, and more particularly to a method, device and computer storage medium for controlling desktop.

### BACKGROUND ART

With development of the internet, open platforms as carriers of applications also get rapid development. A plenty of network applications can be accessed through an open platform, thereby providing rich functionality for users visiting the open platform; furthermore, the open platform further allows users to access desktop provided by the open platform, but not limited to the desktop of the operating system.

Wherein, the desktop provided by the open platform usually sets multiple interfaces, for example, in multiple interfaces of the desktop, one page is configured to place icons of applications relating to music category, and another page is configured to place icons of applications relating to game category; each of icons corresponds to a network application, users can run the network application by clicking on the icon, thereby quickly executing trigger operations to various kinds of network applications with the help of multiple interfaces of the desktop.

However, the window interface of an application being opened in full-screen state in the desktop provided by the open platform will cover the desktop; therefore, the user can not directly input any operations to anyone of interfaces of the desktop, but has to minimize the window interface and execute interface switching operation in the desktop so as to access the interface for executing input operations. Operations between multiple interfaces in the desktop are very complicated.

### SUMMARY OF THE INVENTION

in view of the defects existing in the conventional art mentioned above, in one aspect, the present disclosure provides a method for controlling desktop so as to simplify operations.

In another aspect, the present disclosure further provides a device for controlling desktop so as to simplify operations.

In another aspect, the present disclosure further provides a computer storage medium so as to simplify operations.

A method for controlling desktop, including:

Creating a first interface as a sub-window of a desktop container according to a creating instruction; and

Embedding the first interface created as the sub-window into the desktop container.

In some embodiments, said method for controlling desktop further includes:

Acquiring a selecting operation for a second interface in the first interface having been embedded and displayed full-screen in the desktop container;

Generating a switching instruction corresponding to the selecting operation for the second interface; and

Switching between the first interface and second interface in the desktop container according to the switching instruction.

A device for controlling desktop, including:

A sub-window creating module, configured to create a first interface as a sub-window of a desktop container according to a creating instruction; and

An interface processing module, configured to embed the first interface created as the sub-window into the desktop container.

In some embodiments, said device for controlling desktop further includes:

An operation acquiring module, configured to acquire a selecting operation for a second interface in the first interface having been embedded and displayed full-screen in the desktop container;

An instruction generating module, configured to generate a switching instruction corresponding to the selecting operation for the second interface; and

A switching module, configured to switch between the first interface and second interface in the desktop container according to the switching instruction.

One or more non-transitory computer readable storage medium, including one or more computer executable instructions, the one or more computer executable instructions are to be executed by one or more processors to implement a method for controlling desktop, wherein, the method including:

Creating a first interface as a sub-window of a desktop container according to a creating instruction; and

Embedding the first interface created as the sub-window into the desktop container.

In some embodiments of said one or more non-transitory computer readable storage medium, said method further includes:

Acquiring a selecting operation for a second interface in the first interface having been embedded and displayed full-screen in the desktop container;

Generating a switching instruction corresponding to the selecting operation for the second interface; and

Switching between the first interface and second interface in the desktop container according to the switching instruction.

According to the method, device and computer storage medium for controlling desktop mentioned above, the first interface is created as the sub-window of the desktop container, and then the first interface created as the sub-window of the desktop container is embedded into the desktop container. In this case, the first interface embedded into the desktop container forms one of the interfaces of the desktop, thereby reducing switching operations between interfaces and greatly simplifying operations.

### BRIEF DESCRIPTION OF THE DRAWINGS

FIG. 1 is a flow diagram illustrating the method for controlling desktop according to one embodiment of the present invention;

FIG. 2 is a schematic diagram illustrating the application of the desktop container according to one embodiment of the present invention;

FIG. 3 is a flow diagram illustrating the method for controlling desktop according to another embodiment of the present invention;

FIG. 4 is a flow diagram illustrating the method for switching between the first interface and the second interface in the desktop container according to the switching instruction as shown in FIG. 3;

FIG. 5 is a structural diagram illustrating the device for controlling desktop according to one embodiment of the present invention;

FIG. 6 is a structural diagram illustrating the device for controlling desktop according to another embodiment of the present invention;

FIG. 7 is a structural diagram illustrating the switching module in one embodiment of the present invention.

### PREFERRED EMBODIMENT OF THE INVENTION

As shown in FIG. 1, in one embodiment, a method for controlling desktop includes following steps:

S110, creating a first interface as a sub-window of a desktop container according to a creating instruction.

In one embodiment, the desktop container is configured to carry multiple interfaces, application interfaces and various kinds of components in the desktop. To be specific, a first interface may be application interfaces running in the open platform, the open platform runs in the desktop container, the desktop container carries multiple desktop interfaces in the open platform, and application interfaces running in the open platform, and so on.

In the open platform, the opened first interface displays on the desktop. By means of executing clicking operation to the full-screen control, the creating instruction for creating the first interface is generated, and according to the generated creating instruction, taking the desktop container as the main-window, the first interface is created as the sub-window of the desktop container. To be specific, the full-screen control may be the maximum button or the full-screen button, and etc.

There is a set membership between the desktop container as the main-window and the application interface created as the sub-window. To be specific, the first interface “n” can be created as the sub-window of the desktop container “m” by calling the function “SetParent(n,m)”.

In one embodiment, the first interface being as the application interface, a window handle corresponding to the first interface is acquired, and according to the window handle, the function “SetParent(n,m)” is called to realize creating the sub-window, and the application identification corresponding to the application is taken as the first interface identification; the corresponding interface information can be acquired according to the first interface identification. Wherein, the window handle is configured to identify the memory block occupied by the window resource.

Furthermore, the first interface created as the sub-window may be one or more interfaces; when the first interface contains one interface, there is a one-to-one relationship between the first interface and the sub-window; and when the first interface contains more interfaces, there may be a many-to-many relationship or many-to-one relationship between the first interface and sub-window.

In one embodiment, the first interface created as the sub-window contains multiple interfaces, and multiple sub-windows are created accordingly; in this case, in the desktop container, since sub-windows of the first interface exists, users, when switching randomly between sub-windows, do not require recalling the corresponding function to create sub-windows, thereby avoiding frequently calling system resources, which reduces system load.

In one embodiment, the amount of the created sub-window is one, and multiple first interfaces will share such one sub-window. To be specific, multiple first interfaces will share the created sub-window in the form of columns; in this case, users can view multiple first interfaces through the created sub-window, thereby improving viewing efficiency, which greatly improves convenience in use.

The relationship between the sub-window and the first interface can be flexibly regulated according to requirements in actual operation process.

S130, embedding the first interface created as the sub-window into the desktop container.

In this embodiment, the first interface as the sub-window of the desktop container will be embedded into the desktop container, and a first interface identification is added to a component being configured to assemble interface identifications corresponding to carried interfaces in the desktop container, so as to be convenient for users to access the interfaces and input operations.

In one embodiment, the creating instruction can be a full-screen instruction, and after the step S130, the method further includes: acquiring corresponding interface information by means of triggering the full-screen instruction, and according to the interface information, full-screen displaying the first interface having been embedded, while covering interfaces displayed in the desktop container.

In this embodiment, the interface information is configured to record information such as interface style, page background, etc. The first interface created as the sub-window is embedded into the desktop container, and displayed full-screen according to information recorded in the interface information, such as interface style, page background, and etc. In process of switching between currently displayed interface and the first interface created as the sub-window and to be displayed full-screen in the desktop container, the embedded first interface is displayed full-screen, at this time, the currently displayed interface in the desktop container will be covered by the first interface, thereby being in hidden state.

In another embodiment, in process of full-screen displaying the first interface, an interface identification corresponding to the first interface is added to a component disposed in the desktop container, so as to tab the currently displayed page in the desktop container. The user can select an interface being in hidden state in the component to switch it into the displaying state, thereby displaying it in the desktop container.

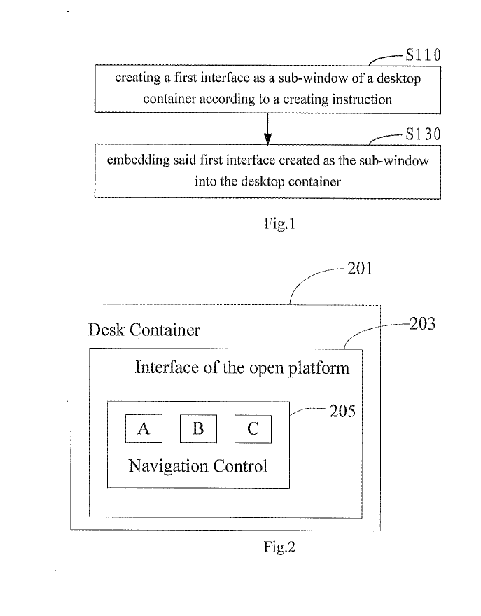

To be specific, the component disposed in the desktop container can be a navigation control, wherein, the first interface identification corresponding to the full-screen displaying first interface and identifications for other interfaces being in hidden state are disposed in the navigation control. To be specific, the navigation control contains information such as interface names, interface icons and interface identifications and so on corresponding to each of interfaces carried in the desktop container. The interface icons and interface names corresponding to each of interfaces will be displayed in the navigation control, and each of interfaces will be uniquely identified by means of the interface identifications. For example, as shown in FIG. 2, an interface 203 of the open platform runs in the desktop container 201, and a navigation control 205 is disposed in the desktop container 201. The navigation control 205 displays three interface icons respectively corresponding to three interfaces A, B and C, wherein, A, B and C are interface names; if the interface is an application interface, the interface name can be an application name which corresponds to a unique interface identification. The user, by means of viewing interface icons and interface names on the navigation control 205, can acknowledge the interface currently displayed in the desktop container 201 and/or the application interface running in full-screen state, and can further trigger the selecting operation to the interface icon corresponding to the interface in hidden state, in this case, the switching process between currently displayed interface and the interface corresponding to the selecting operation will be triggered.

In one embodiment, for the users' convenience of viewing, the navigation control displays the interface icons and/or interface names corresponding to each of interfaces, and the interface identification, as the attribute of the interface icon, is associated to the corresponding interface icon and interface name. Correspondingly, with respect to the first interface, which is created as the sub-window, embedded into the desktop container and full-screen displayed, the interface icon and/or interface name corresponding to the first interface is added into the navigation control, and the corresponding interface identification is added to be associated to the interface icon.

In addition, with respect to the first interface displayed in the desktop container in full-screen, the corresponding interface icon and/or interface name of the first interface on the navigation control will further be tabbed, thereby further being convenient for users to acknowledge the interface name corresponding to currently displayed interface.

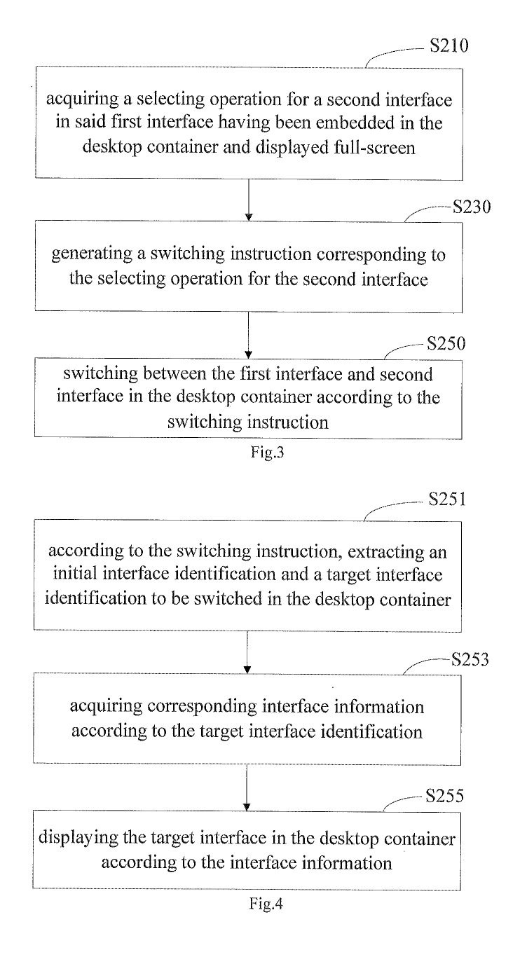

In another embodiment as shown in FIG. 3, after the step S1.30, the method further includes following steps:

S210, acquiring a selecting operation for a second interface in said first interface having been embedded in the desktop container and displayed full-screen.

In this embodiment, the second interface is the interface being in hidden state in the desktop container, which may be an interface in which an application is placed, or may be anyone of interfaces of the desktop. In the desktop container, the first interface displayed full-screen is embedded into the desktop container to display, and the interface set by the desktop is a hidden interface which is not displayed in the desktop container; and the interface being in hidden state in the desktop container is not only limited to the interface disposed in the desktop, but may further include other application interfaces.

The selecting operation to the second interface identification is implemented for selecting an interface in hidden state, and the second interface corresponding to the selecting operation is the interface which the user expects to switch into the desktop container to display full-screen.

S230, generating a switching instruction corresponding to the selecting operation for the second interface.

In this embodiment, the step S230 is specific as following steps: according to the selecting operation for the second interface, acquiring a second interface identification and a first interface identification, and generating the switching instruction according to the second interface and first interface. The selecting operation for the second interface is implemented for triggering the switching between the interface embedded and full-screen displayed in the desktop container and the selected interface. In the desktop container in which the first interface is embedded and displayed full-screen, the selected second interface is acquired through the selecting operation for the second interface, further the selected second interface identification corresponding to the second interface and the first interface identification corresponding to the first interface currently displayed full-screen are acquired; and the switching instruction is generated according to the second interface identification of the selected interface and the first interface identification corresponding to the first interface currently displayed full-screen.

S250, switching between the first interface and second interface in the desktop container according to the switching instruction.

In this embodiment, the first interface to be switched to hidden state and the second interface to be switched to display in the desktop container are acquired according to the switching instruction, and then the first interface to be switched into hidden state is removed, thereby displaying the second interface in the desktop container corresponding to the selecting operation.

To be specific, according to the tailoring principle, the size of the interface displayed full-screen is consistent with the capacity of the desktop container, which means the first interface currently displayed full-screen overlaps with the accommodate space provided by the desktop container. In one embodiment, the position of the interface can be identified in the form of coordinates, the interface, whose coordinates fall within the coordinate range corresponding to the accommodate space provided by the desktop container, will be displayed in the desktop container, and the desktop, whose coordinates go beyond the coordinate range corresponding to the accommodate space provided by the desktop container, is the second interface which will not be displayed.

For example, in the desktop container, the coordinate corresponding to the lower-left corner of the first interface currently displayed full-screen is (0, 0). The range of the accommodate space of the desktop container is defined by coordinates at the lower-left corner and upper-right corner, and the coordinate at the lower-left corner is (0, 0) and the coordinate at the upper-right corner is (1400, 900), and the coordinate corresponding to the upper-right corner of the first interface currently displayed full-screen is (1400, 900). The interface whose coordinates at the lower-left corner and the upper-right corner are not located within the accommodate space will be the second interface, and will not be displayed in the desktop container.

The switching process between two interfaces, which are set as continuous interfaces, can be realized by means of sliding in a certain direction. For example, in the desktop container, the coordinate corresponding to the lower-left corner of the first interface B currently displayed full-screen is (0, 0), and the coordinate corresponding to the upper-right corner is (1400, 900); with respect to the second interface A being set continuous with the first interface B, the corresponding coordinate at the lower-left corner thereof is (−1400, 0), and the corresponding coordinate at the upper-right corner is (0, 900); the second interface A is not located within the accommodate space of the desktop container, so it is in hidden state.

The interface currently displayed full-screen in the desktop container can be switched from the first interface B to the second interface A by sliding the page in rightward horizontally; the coordinate corresponding to the lower-left corner of the second interface A slides from (−1400, 0) to (0, 0), and the coordinate corresponding to the upper-right corner slides to (1440, 900); at this time, the first interface B set continuous with the second interface A will be slid accordingly to become a hidden page, thereby achieving seamless switching between pages in the desktop container.

Moreover, in another embodiment, the present disclosure further provides a method for controlling the desktop, including aforementioned steps S210 to S250. In this embodiment, the architecture that the first interface is embedded into the desktop container and displayer full-screen makes user capable of switching between interfaces through simplified operations, thereby providing a very convenient manner for the desktop.

In one embodiment as shown in FIG. 4, the aforementioned step S250 is specific as following steps:

S251, according to the switching instruction, extracting an initial interface identification and a target interface identification to be switched in the desktop container.

In this embodiment, the initial interface identification corresponds to the first interface, which is displayed full-screen currently in the desktop container; the target interface identification corresponds to the selected second interface, which is to be displayed in the desktop container.

S253, acquiring corresponding interface information according to the target interface identification.

In this embodiment, the interface information corresponding to the target interface is acquired, thereby being convenient for displaying according to the interface information in subsequent processes.

S255, displaying the target interface in the desktop container according to the interface information.

In another embodiment, when the operation of cancelling full-screen for the first interface in full-screen state is acquired, the aforementioned method for controlling the desktop further includes the following steps: removing the corresponding interface according to the operation of cancelling full-screen, and deleting the corresponding first interface identification, and the associated interface icons and interface names from the navigation control.

In this embodiment, the operation of cancelling full-screen may be a close operation to the first interface, or may be a minimizing operation to the first interface, and so on. According to the acquired operation of cancelling full-screen, the first interface, of which the full-screen state is cancelled, is removed from the multiple interfaces in the desktop container, and the first interface identification, interface icon and interface names associated with the first interface are deleted from the navigation control, such that the first interface does not full-screen display in the desktop container any longer.

In one embodiment as shown in FIG. 5, a device for controlling the desktop includes: a sub-window creating module 110 and an interface processing module 130.

The sub-window creating module 110 is configured to create a first interface as a sub-window of a desktop container according to a creating instruction.

In one embodiment, the desktop container is configured to carry multiple interfaces, application interfaces and various kinds of components in the desktop. To be specific, a first interface may be application interfaces running in the open platform, the open platform runs in the desktop container, the desktop container carries multiple desktop interfaces in the open platform, and application interfaces running in the open platform, and so on.

In the open platform, the opened first interface displays on the desktop. By means of executing clicking operation to the full-screen control, according to the generated creating instruction, the sub-window creating module 110, taking the desktop container as the main-window, creates the first interface as the sub-window of the desktop container. To be specific, the full-screen control may be the maximum button or the full-screen button, and etc.

There is a set membership between the desktop container as the main-window and the application interface created as the sub-window. To be specific, the sub-window creating module 110 can create the first interface “n” as the sub-window of the desktop container “m” by calling the function “SetParent(n,m)”.

In one embodiment, the first interface being as the application interface, the sub-window creating module 110 acquires a window handle corresponding to the first interface, and according to the window handle, calls the function “SetParent(n,m)” to realize creating sub-window, and takes the application identification corresponding to the application as the first interface identification, so as to acquire the corresponding interface information according to the first interface identification. Wherein, the window handle is configured to identify the memory block occupied by the window resource.

Furthermore, the first interface created as the sub-window may be one or more interfaces; when the first interface contains one interface, there is a one-to-one relationship between the first interface and the sub-window; and when the first interface contains more interfaces, there may be a many-to-many relationship or many-to-one relationship between the first interface and sub-window.

In one embodiment, the first interface created as the sub-window contains multiple interfaces, and multiple sub-windows are created accordingly; in this case, in the desktop container, since sub-windows of the first interface exist, users, when switching randomly between sub-windows, do not require recalling the corresponding function to create sub-windows, thereby avoiding frequently calling system resources, which reduces system load.

In one embodiment, the amount of the created sub-window is one, and multiple first interfaces will share such one sub-window. To be specific, multiple first interfaces will share the created sub-window in the form of columns; in this case, users can view multiple first interfaces through the created sub-window, thereby improving viewing efficiency, which greatly improves convenience in use.

The relationship between the sub-window and the first interface can be flexibly regulated according to requirements in actual operation process.

The interface processing module 130 is configured to embed the first interface created as the sub-window into the desktop container.

In this embodiment, the first interface as the sub-window of the desktop container will be embedded into the desktop container by the interface processing module 130, and is full-screen displayed according to the interface information, and a first interface identification is added to a component being configured to assemble interface identifications corresponding to carried interfaces in the desktop container, so as to be convenient for users to access the interfaces and input operations.

In one embodiment, the creating instruction can be a full-screen instruction, and the interface processing module 130 is further configured to acquire corresponding interface information by means of triggering the full-screen instruction, and according to the interface information, full-screen display the first interface having been embedded in full-screen, while covering interfaces displayed in the desktop container.

In this embodiment, the interface information is configured to record information such as interface style, page background, etc. The interface processing module 130 embeds the first interface created as the sub-window into the desktop container, and full-screen displays the first interface according to information recorded in the interface information such as interface style, page background, and etc. In process of switching interfaces between currently displayed interface and the first interface created as the sub-window and to be displayed full-screen in the desktop container, the interface processing module 130 full-screen displays the embedded first interface, at this time, the currently displayed interface in the desktop container will be covered by the first interface, thereby being in hidden state.

In another embodiment, in process of full-screen displaying the first interface, the interface processing module 130 further adds an interface identification corresponding to the first interface to a component disposed in the desktop container, so as to tab currently displayed page in the desktop container. The user can select an interface being in hidden state in the component to switch it into the displaying state, thereby displaying it in the desktop container.

To be specific, the component disposed in the desktop container can be a navigation control, wherein, the first interface identification corresponding to the full-screen displaying first interface and identifications for other interfaces being in hidden state are disposed in the navigation control. To be specific, the navigation control contains information such as interface names, interface icons and interface identifications and so on corresponding to each of interfaces carried in the desktop container. The interface icons and interface names corresponding to each of interfaces will be displayed in the navigation control, and each of interfaces will be uniquely identified by means of the interface identifications.

In one embodiment, for the users' convenience of viewing, the navigation control displays the interface icons and/or interface names corresponding to each of interfaces, and the interface identification, as the attribute of the interface icon, is associated to the corresponding interface icon and interface name. Correspondingly, with respect to the first interface, which is created as the sub-window, embedded into the desktop container and full-screen displayed, the interface processing module 130 adds the interface icon and/or interface name corresponding to the first interface into the navigation control, and adds the corresponding interface identification to be associated to the interface icon.

In addition, with respect to the first interface displayed in the desktop container in full-screen, the interface processing module 130 further tabs the corresponding interface icon and/or interface name of the first interface on the navigation control, thereby further being convenient for users to acknowledge the interface name corresponding to currently displayed interface.

In another embodiment as shown in FIG. 6, the aforementioned device for controlling desktop further includes: operation acquiring module 210, instruction generating module 230 and switching module 250.

The operation acquiring module 210 is configured to acquire a selecting operation for a second interface in the first interface having been embedded in the desktop container and displayed full-screen.

In this embodiment, the second interface is the interface being in hidden state in the desktop container, which may be an interface in which an application is placed, or may be anyone of interfaces of the desktop. In the desktop container, the first interface displayed full-screen is embedded into the desktop container to display, and the interface set by the desktop is a hidden interface which is not displayed in the desktop container; and the interface being in hidden state in the desktop container is not only limited to the interface disposed in the desktop, but may further include other application interfaces.

The selecting operation to the second interface identification is implemented for selecting an interface in hidden state, and the second interface corresponding to the selecting operation is the interface which the user expects to switch into the desktop container to display full-screen.

The instruction generating module 230 is configured to generate a switching instruction corresponding to the selecting operation for the second interface.

In this embodiment, the instruction generating module 230 is further configured to, according to the selecting operation for the second interface, acquire a second interface identification and a first interface identification, and generate the switching instruction according to the second interface and first interface. The selecting operation for the second interface is implemented for triggering the switching between the interface embedded and full-screen displayed in the desktop container and the selected interface. In the desktop container in which the first interface is embedded and displayed full-screen, the instruction generating module 230 acquires the selected second interface through the selecting operation for the second interface, further acquires the selected second interface identification corresponding to the second interface and the first interface identification corresponding to the first interface currently displayed full-screen; and generates the switching instruction according to the second interface identification of the selected interface and the first interface identification corresponding to the first interface currently displayed full-screen.

The switching module 250 is configured to switch between the first interface and second interface in the desktop container according to the switching instruction.

In this embodiment, the switching module 250 acquires the first interface to be switched to hidden state and the second interface to be switched to display in the desktop container according to the switching instruction, and then removes the first interface to be switched into hidden state, thereby displaying the second interface in the desktop container corresponding to the selecting operation.

To be specific, according to the tailoring principle, the size of the interface displayed full-screen is consistent with the capacity of the desktop container, which means the first interface currently displayed full-screen overlaps with the accommodate space provided by the desktop container. In one embodiment, the position of the interface can be identified in the form of coordinates, the interface, whose coordinates fall within the coordinate range corresponding to the accommodate space provided by the desktop container, will be displayed in the desktop container, and the desktop, whose coordinates go beyond the coordinate range corresponding to the accommodate space provided by the desktop container, is the second interface which will not be displayed.

For example, in the desktop container, the coordinate corresponding to the lower-left corner of the first interface currently displayed full-screen is (0, 0). The range of the accommodate space of the desktop container is defined by coordinates at the lower-left corner and upper-right corner, and the coordinate at the lower-left corner is (0, 0) and the coordinate at the upper-right corner is (1400, 900), and the coordinate corresponding to the upper-right corner of the first interface currently displayed full-screen is (1400, 900). The interface whose coordinates at the lower-left corner and the upper-right corner are not located within the accommodate space will be the second interface, and will not be displayed in the desktop container.

The switching module 250 can realize the switching process between two interfaces, which are set as continuous interfaces, by means of sliding in a certain direction. For example, in the desktop container, the coordinate corresponding to the lower-left corner of the first interface B currently displayed full-screen is (0, 0), and the coordinate corresponding to the upper-right corner is (1400, 900); with respect to the second interface A being set continuous with the first interface B, the corresponding coordinate at the lower-left corner thereof is (−1400, 0), and the corresponding coordinate at the upper-right corner is (0, 900); the second interface A is not located within the accommodate space of the desktop container, so it is in hidden state.

The interface currently displayed full-screen in the desktop container can be switched from the first interface B to the second interface A by sliding the page in rightward horizontally; the coordinate corresponding to the lower-left corner of the second interface A slides from (−1400, 0) to (0, 0), and the coordinate corresponding to the upper-right corner slides to (1440, 900); at this time, the first interface B set continuous with the second interface A will be slid accordingly to become a hidden page, thereby achieving seamless switching between pages in the desktop container.

Moreover, in another embodiment, the present disclosure further provides a device for controlling the desktop, including aforementioned operation acquiring module 210, instruction generating module 230 and switching module 250. In this embodiment, the architecture that the first interface is embedded into the desktop container and displayer full-screen makes user capable of switching between interfaces through simplified operations, thereby providing a very convenient manner for the desktop.

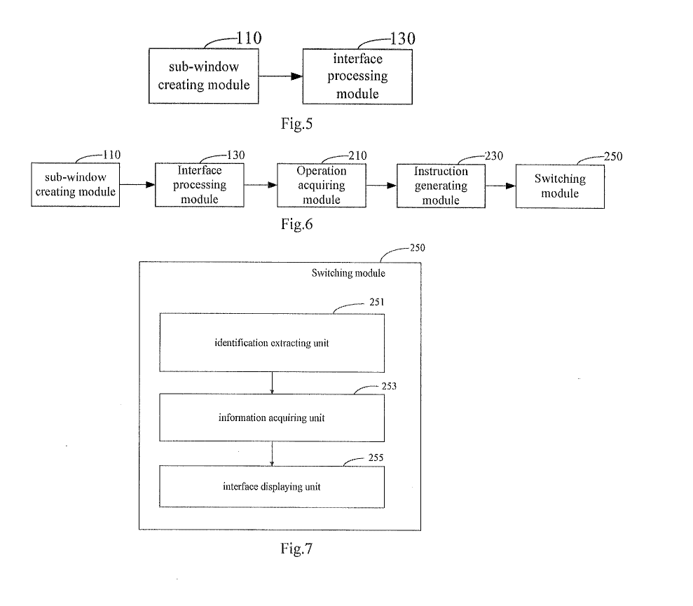

In one embodiment as shown in FIG. 7, the aforementioned switching module 250 includes an identification extracting unit 251, an information acquiring unit 253 and an interface displaying unit 255.

The identification extracting unit 251 is configured to extract an initial interface identification and a target interface identification to be switched in the desktop container according to the switching instruction.

In this embodiment, the initial interface identification corresponds to the first interface, which is displayed full-screen currently in the desktop container; the target interface identification corresponds to the selected second interface, which is to be displayed in the desktop container.

The information acquiring unit 253 is configured to acquire corresponding interface information according to the target interface identification.

In this embodiment, the information acquiring unit 253 acquires interface information corresponding to the target interface, thereby being convenient for displaying according to the interface information in subsequent processes.

The interface displaying unit 255 is configured to display a target interface in the desktop container according to the interface information.

In another embodiment, when the operation of cancelling full-screen for the first interface in full-screen state is acquired, the aforementioned device for controlling the desktop further removes the corresponding interface according to the operation of cancelling full-screen, and deletes the corresponding first interface identification, and the associated interface icons and interface names from the navigation control.

In this embodiment, the operation of cancelling full-screen may be a close operation to the first interface, or may be a minimizing operation to the first interface, and so on. According to the acquired operation of cancelling full-screen, the first interface, of which the full-screen state is cancelled, is removed from the multiple interfaces in the desktop container, and the first interface identification, interface icon and interface names associated with the first interface are deleted from the navigation control, such that the first interface does not full-screen display in the desktop container any longer.

The aforementioned device for controlling desktop can run on various kinds of equipment carrying open platforms like web-clients, desktop clients and so on.

The method, device and computer storage medium for controlling desktop mentioned above are adopted to create the first interface as the sub-window of the desktop container, and then embed the first interface created as the sub-window of the desktop container to the desktop container. In this case, the first interface embedded into the desktop container forms one of the interfaces of the desktop, thereby reducing switching operations between interfaces and greatly simplifying operations.

It should be understood by those skilled in the art that all or part of the processes in the above mentioned embodiments of the method may be realized through relevant hardware commanded by computer program instructions. Said program may be saved in a computer readable storage medium, and said program may include the processes in the above mentioned embodiments of the method when it is executed. Wherein, said storage medium may be a diskette, optical disk, ROM (Read-Only Memory) or RAM (Random Access Memory), and so on.

It should be understood by those skilled in the art that what described above are preferred embodiments of the present invention. Various modifications and replacements may be made therein without departing from the theory of the present disclosure, which should also be seen in the scope of the present disclosure.

What is claimed is:

1. A method for controlling desktop, comprising:
creating a first interface as a sub-window of a desktop container according to a creating instruction; and
embedding said first interface created as the sub-window into the desktop container.

2. The method for controlling desktop according to claim 1, wherein, said first interface created as the sub-window contains one or more interfaces; when said first interface contains one interface, there is a one-to-one relationship between said first interface and sub-window; and when said first interface contains more interfaces, there is a many-to-many relationship or many-to-one relationship between said first interface and sub-window.

3. The method for controlling desktop according to claim 1, wherein, said creating instruction is a full-screen instruction, and after embedding said first interface created as the sub-window into the desktop container, said method further comprises:
acquiring corresponding interface information by means of triggering said full-screen instruction, and according to said interface information, full-screen displaying said first interface having been embedded, while covering interfaces displayed in the desktop container.

4. The method for controlling desktop according to claim 1, wherein, after acquiring corresponding interface information by means of triggering said full-screen instruction, and according to said interface information, full-screen displaying said first interface having been embedded, while covering interfaces displayed in the desktop container, said method further comprises:
adding a first interface identification to a component being configured to assemble interface identifications corresponding to carried interfaces in the desktop container, so as to tab a page currently displayed in the desktop container.

5. The method for controlling desktop according to claim 1, wherein, after embedding said first interface created as the sub-window into the desktop container, said method further comprises following steps:
acquiring a selecting operation for a second interface in said first interface having been embedded and full-screen displayed in the desktop container;
generating a switching instruction corresponding to the selecting operation for said second interface; and
switching between said first interface and second interface in the desktop container according to said switching instruction.

6. The method for controlling desktop according to claim 5, wherein, said step of generating a switching instruction corresponding to the selecting operation for said second interface further comprises:
acquiring a second interface identification and a first interface identification according to the selecting operation for said second interface, and generating said switching instruction according to said second interface identification and first interface identification.

7. The method for controlling desktop according to claim 6, wherein, said step of switching between said first interface and second interface in the desktop container according to said switching instruction further comprises:
extracting an initial interface identification and a target interface identification to be switched in the desktop container according to said switching instruction; said initial interface identification is the first interface identification, and said target interface identification is the second interface identification;
acquiring corresponding interface information according to said target interface identification; and
displaying a target interface in the desktop container according to said interface information.

8. A device for controlling desktop, comprising:
a sub-window creating module, configured to create a first interface as a sub-window of a desktop container according to a creating instruction; and
an interface processing module, configured to embed said first interface created as the sub-window into the desktop container.

9. The device for controlling desktop according to claim 8, wherein, said first interface created as the sub-window contains one or more interfaces; when said first interface contains one interface, there is a one-to-one relationship between said first interface and the sub-window are one-to-one relationships; and when said first interface contains more interfaces, there is a many-to-many relationship or many-to-one relationship between said first interface and sub-window.

10. The device for controlling desktop according to claim 8, wherein, said creating instruction is a full-screen instruction, and said interface processing module is further configured to acquire corresponding interface information by means of triggering said full-screen instruction, and according to said interface information, display said first interface having been embedded in full-screen, while covering interfaces displayed in the desktop container.

11. The device for controlling desktop according to claim 8, wherein, said interface processing module is further configured to add a first interface identification to a component being configured to assemble interface identifications corresponding to carried interfaces, in the desktop container, so as to tab a page currently displayed in the desktop container.

12. The device for controlling desktop according to claim 8, further comprising:
an operation acquiring module, configured to acquire a selecting operation for a second interface in said first interface having been embedded and displayed full-screen in the desktop container;
an instruction generating module, configured to generate a switching instruction corresponding to the selecting operation for said second interface; and
a switching module, configured to switch between said first interface and second interface in the desktop container according to said switching instructing.

13. The device for controlling desktop according to claim 12, wherein, said instruction generating module is further configured to acquire a second interface identification and a first interface identification according to the selecting operation for said second interface, and generate said switching instruction according to said second interface identification and first interface identification.

14. The device for controlling desktop according to claim 13, wherein, said switching module comprises:
an identification extracting unit, configured to extract an initial interface identification and a target interface identification to be switched in the desktop container according to said switching instruction; said initial interface identification is the first interface identification and said target interface identification is the second interface identification;
an information acquiring unit, configured to acquire corresponding interface information according to said target identification; and
an interface displaying unit, configured to display a target interface in the desktop container according to said interface information.

15. One or more non-transitory computer readable storage medium, including one or more computer executable instructions, said one or more computer executable instructions are to be executed by one or more processors to implement a method for controlling desktop; wherein, said method comprises:
creating a first interface as a sub-window of a desktop container according to a creating instruction; and
embedding said first interface created as the sub-window into the desktop container.

16. One or more non-transitory computer readable storage medium according to claim 15, wherein, said method further comprises:
acquiring a selecting operation for a second interface in said first interface having been embedded and full-screen displayed in the desktop container;
generating a switching instruction corresponding to the selecting operation for said second interface; and
switching between said first interface and second interface in the desktop container according to said switching instruction.
